(19) United States
(12) Patent Application Publication
(10) Pub. No.: US 2008/0159105 A1
(43) Pub. Date: Jul. 3, 2008

(54) Detection of Spindle Motor Degradation

(75) Inventors: Hemmant Gopal, Newton, MA (US); Bijan Tehrani, Shrewsbury, MA (US); David J. Kaphammer, Lyons, CO (US); Mirmehdi L. Abrishamchian, Shrewsbury, MA (US)

Correspondence Address: HENSLEY KIM & HOLZER, LLC, 1660 LINCOLN STREET, SUITE 3000, DENVER, CO, 80264, US

(73) Assignee: SEAGATE TECHNOLOGY LLC, Scotts Valley, CA (US)

(21) Appl. No.: 11/617,522

(22) Filed: Dec. 28, 2006

(51) Int. Cl. G11B 20/18

(52) U.S. Cl. 369/53.43

(57) ABSTRACT

Systems and methods are disclosed for detecting spindle motor degradation. A method includes issuing an alert if a difference between feed forward compensation signals of repeatable runout determined at a first time and feed forward compensation signals of repeatable runout determined at a second time satisfies a first threshold condition. A method may further include issuing an alert if a delta difference between a first difference and a second difference satisfies a second threshold condition. The first difference represents a difference between the feed forward compensation signals of repeatable runout at the first time and the feed forward compensation signals of repeatable runout at the second time. The second difference represents a difference between the feed forward compensation signals of repeatable runout at the first time and feed forward compensation signals of repeatable runout at a third time.

### SUMMARY

Spindle motors can degrade or become faulty in a number of ways. For example, many spindle motors include oil bearings that facilitate the smooth rotation of the motor. However, the oil may leak out of the motor, increasing the friction within the motor and eventually leading to a seizure of the motor. However, by monitoring characteristics of certain control signals applied to a track-following actuator associated with the motor, a pending spindle motor failure may be predicted.

In one implementation, an alert is issued if a difference between feed forward compensation signals of repeatable runout determined at a first time and feed forward compensation signals of repeatable runout determined at a second time satisfies a first threshold condition.

In another implementation, an alert is issued if a delta difference between a first difference and a second difference satisfies a second threshold condition. The first difference represents a difference between feed forward compensation signals of repeatable runout at a first time and feed forward compensation signals of repeatable runout at a second time. The second difference represents a difference between feed forward compensation signals of repeatable runout at a first time and feed forward compensation signals of repeatable runout at a third time.

In some implementations, determining the feed forward compensation signals of repeatable runout at the first time may comprise determining adaptive runout correction system (ARCS) values at the first time and determining the feed forward compensation signals of repeatable runout at the second time may comprises determining ARCS values at the second time.

In yet another implementation a system may include control circuitry. The control circuitry is configured to issue an alert if a difference between feed forward compensation signals of repeatable runout determined at a first time and feed forward compensation signals of repeatable runout determined at a second time satisfies a first threshold condition.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. It should also be understood that, although disc drive implementations are described here, the described technology may be applied to other systems.

### BRIEF DESCRIPTIONS OF THE DRAWINGS

FIG. 1 illustrates a plan view of an example disc drive;

FIG. 2 illustrates the example functional components of a disc drive;

FIG. 3 illustrates a plan view of an example disc drive and an exemplary track to be followed by an actuator arm;

FIG. 4 illustrates an exemplary time or event based chart relating to detecting spindle motor degradation;

FIG. 5 illustrates an example first stage operations for detecting spindle motor degradation;

FIG. 6 illustrates example second stage operations for detecting spindle motor degradation; and

FIG. 7 illustrates example first and second stage operations for detecting spindle motor degradation.

### DETAILED DESCRIPTION

Devices having a disc drive commonly experience problems with data loss associated with spindle motor degradation and/or failure. If the spindle motor experiences low oil, for example, the spindle motor may begin to exhibit symptoms, such as wobble, which can result in undesirable performance and can ultimately cause the spindle motor to seize or fail. Seizure of the spindle motor will result in failure of the operation of the disc drive, ultimately resulting in loss of valuable user or operator data. Thus, it would be desirable to have a system and/or methods for detecting and predicting spindle motor problems or failures before they happen, so that valuable data may be retrieved before failure of the disc drive and loss of data occurs.

A disc drive is a data storage device used to store digital data. A typical disc drive includes a number of rotatable recording discs (i.e., storage medium discs) that are axially aligned and mounted to a spindle motor for rotation at a high rotational velocity. A corresponding array of read/write heads positioned on actuator arms access tracks defined on the respective disc surfaces to write data to and read data from the discs. Although certain implementations are described herein in the context of disc drives, the described technology may be employed in other systems as well.

One implementation of the described technology detects or predicts spindle motor degradation or impending malfunction by detecting effects indicative of spindle motor operational problems or failure. An exemplary method of detecting these problems utilizes an algorithm to analyze data to warn users of potential spindle motor (e.g. disc drive) failures before the actual occurrence, so that the user has time to backup valuable data before complete spindle motor (e.g. disc drive) failure occurs.

A method of detecting spindle motor degradation may comprise issuing an alert if a first difference between feed forward compensation signals of repeatable runout determined at a first time and feed forward compensation signals of repeatable runout determined at a second time satisfies a first threshold condition. If the first difference exceeds the first threshold condition, then a flag may be set to trigger or commence further measurements or methods of detection.

If the first difference exceeds the first threshold condition, the method may further comprise determining a second difference between feed forward compensation signals of repeatable runout at the first time and feed forward compensation signals of repeatable runout at a third time. The difference between the first and second differences will then be determined. If the difference between the first and second differences satisfies a second threshold condition, then an alert will be issued. Issuing the alert may comprise setting another flag or notifying a user to commence data backup operations immediately due to impending spindle motor (e.g. disc drive) failure. If the difference between the first and second differences does not satisfy the second threshold condition, then the first threshold condition may be recalibrated, as will be described in more detail below.

Predicting when a spindle motor begins to degrade can be very advantageous to a user because it can give the user time to backup valuable data before total spindle motor (e.g. disc drive) failure occurs. Once the spindle motor seizes or fails, the disc will stop rotating, the actuator arm will return to its resting or de-energized position, and the information on the disc will no longer be accessible to the user. This loss of valuable data due to spindle motor problems and/or failure could be prevented by predicting the spindle motor degradation before failure occurs. When the spindle motor begins to exhibit wobble, the methods disclosed herein may be used to determine if failure is imminent and notify a user to begin data backup operations before failure occurs.

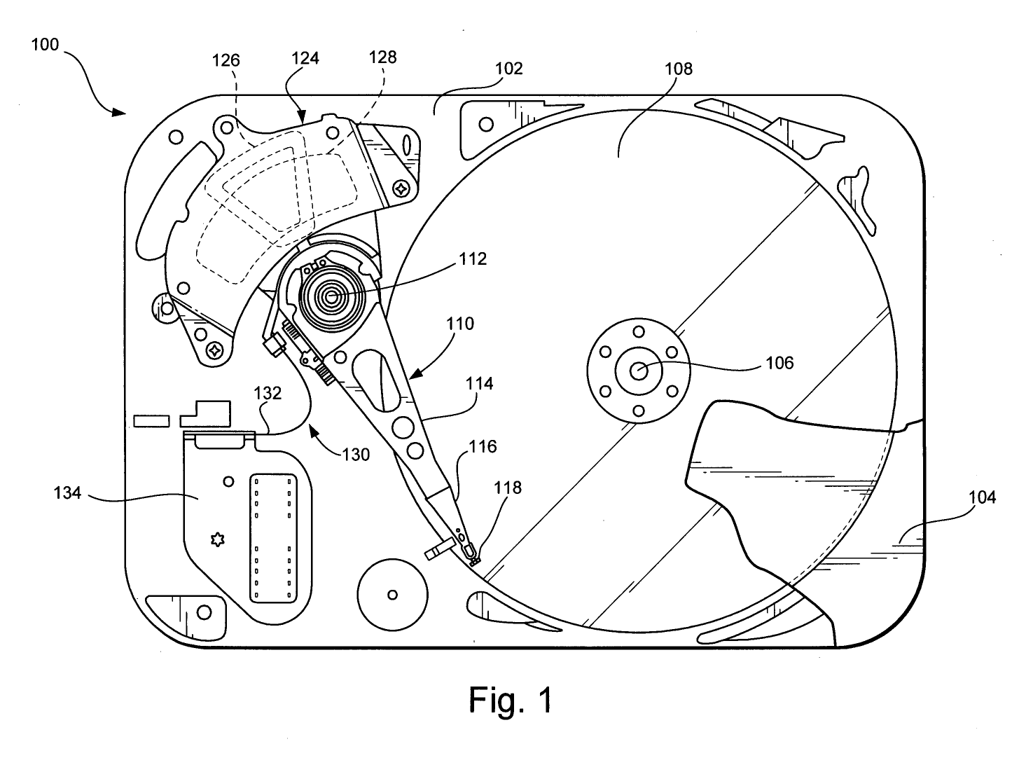

FIG. 1 illustrates a plan view of an example disc drive 100. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106 which rotates one or more storage medium discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118 which includes an air bearing slider enabling the head 118 to fly in close proximity above the corresponding surface of the associated disc 108.

During a seek operation, the track position of the head 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108. The spindle motor 106 is typically de-energized when the disc drive 100 is not in use for extended periods of time.

A flex assembly 130 provides the requisite electrical connection paths for the actuator assembly 110 while allowing pivotal movement of the actuator assembly 110 during operation. The flex assembly 130 includes a printed circuit board 134 to which a flex cable 132 connected with the actuator assembly 100 and leading to the head 118 is connected. The flex cable 132 may be routed along the actuator arms 114 and the flexures 116 to the heads 118. The printed circuit board 134 typically includes circuitry for controlling the write currents applied to the heads 118 during a write operation and a preamplifier for amplifying read signals generated by the heads 118 during a read operation. The flex assembly 134 terminates at a flex bracket 136 for communication through the base deck 102 to a disc drive printed circuit board (not shown) mounted to the bottom side of the disc drive 100.

In an exemplary implementation, servo control circuitry in the disc drive 100 includes a power amp, a controller, and a memory containing program code for detecting a large shock, performing corrective action, and/or performing RAW verification.

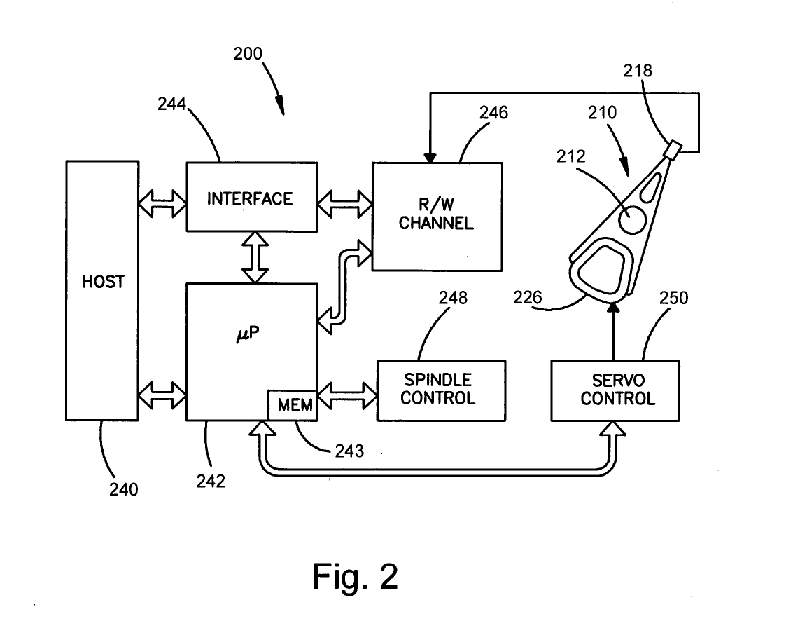

FIG. 2 illustrates the primary functional components of a disc drive incorporating one of the various implementations of the described technology and generally shows the main functional circuits that are resident on the disc drive printed circuit board and used to control the operation of the disc drive. The disc drive is operably connected to a host computer 240 in a conventional manner. Control communication paths are provided between the host computer 240 and a disc drive microprocessor 242, the microprocessor 242 generally providing top level communication and control for the disc drive in conjunction with programming for the microprocessor 242 stored in microprocessor memory (MEM) 243. The MEM 243 can include random access memory (RAM), read only memory (ROM) and other sources of resident memory for the microprocessor 242.

The discs are rotated at a constant high speed by a spindle motor control circuit 248, which electrically communicates with the spindle motor through the use, typically, of back electromotive force (BEMF) sensing. During a seek operation, wherein an actuator 210 moves heads 218 between tracks on the storage media, the position of the heads 218 is controlled through the application of current to the coil 226 of a voice coil motor. A servo control circuit 250 provides such control. During a seek operation the microprocessor 242 receives information regarding the velocity of the head 218, and uses that information in conjunction with a velocity profile stored in memory 243 to communicate with the servo control circuit 250, which will apply a controlled amount of current to the voice coil motor coil 226, thereby causing the actuator assembly 210 to be pivoted.

Data is transferred between the host computer 240 or other device and the disc drive by way of an interface 244, which typically includes a buffer to facilitate high speed data transfer between the host computer 240 or other device and the disc drive. Data to be written to the disc drive is thus passed from the host computer 240 to the interface 244 and then to a read/write channel 246, which encodes and serializes the data and provides the requisite write current signals to the heads 218. To retrieve data that has been previously stored in the data storage device, read signals are generated by the heads 218 and provided to the read/write channel 246, which performs decoding and error detection and correction operations and outputs the retrieved data to the interface 244 for subsequent transfer to the host computer 240 or other device.

In an exemplary implementation, servo control 250 in the disc drive includes a power amp, a controller, and a memory containing program code for detecting a large shock, performing corrective action, and/or performing RAW verification.

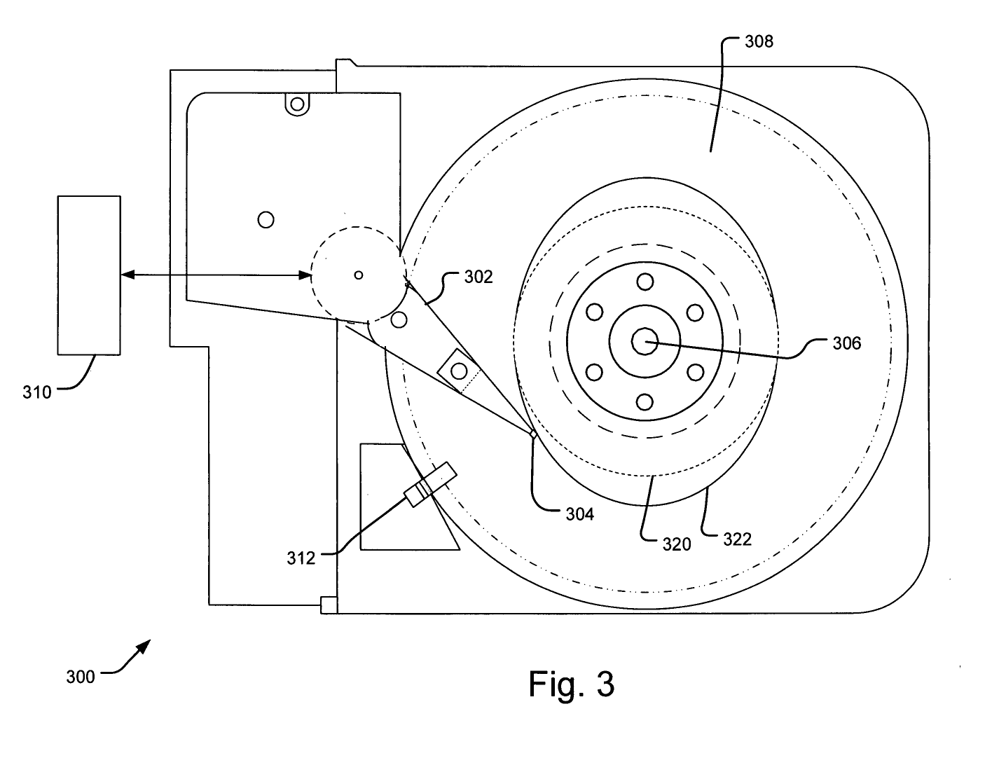

FIG. 3 illustrates an exemplary disc drive 300 having a control circuitry 310 operably associated with actuator arm 302. The spindle motor 306 rotates the one or more storage medium discs 308 at a constant high speed. Information is written to and read from a circular track 322 on the disc 308 while the disc 308 is rotating through the use of the head 304 on the actuator arm 302. The head 304 follows the circular track 322 and reads and writes data from the disc 308.

Typically, under normal operating conditions, the head 304 will follow a circular track 320 (shown using a dashed line) without deviating from the track 320. However, if the spindle motor 306 begins to degrade or experience problems, such as low oil, it will cause wobble, resulting in a non-circular track 322, which is more of an oval than a circle. (Note that track 322 has been exaggerated in FIG. 3 for clarity of illustration herein.) The wobble or deviation (shown as track 322) from the typically circular track 320 may be measured and analyzed to predict when spindle motor degradation, and ultimately spindle motor failure, will occur.

Detecting spindle motor degradation involves measuring the wobble or deviation of the head 304 from a typical circular track (such as track 320), as shown in FIG. 3. Position error signals (PES) are measured to provide information on the distance between an expected position of the head 304 relative to the track and an actual position of the head 304 relative to the track. PES measurements are received and stored for a defined number of revolutions for each of the plurality of disc surfaces. The PES measurements are used to measure and analyze runout for a defined number of revolutions.

Runout refers to the track eccentricity in a rotating disc. Runout consists of two components: a non-repeatable runout (NRRO) component and a repeatable runout (RRO) component. Non-repeatable runout is defined as the part of the disc runout that is not repeatable with each revolution of the disc. Non-repeatable runout can be caused by bearing defects, noise, spindle motor imperfections, servo loop response errors, etc. Repeatable runout is the term used to describe disc runout that is repeatable with each revolution of the disc. Repeatable runout can be the result of errors in the servo track writer, disc shift (eccentricity), etc.

Detecting spindle motor degradation begins by taking PES measurements, which will consist of both a RRO component and a NRRO component. The RRO component is typically synchronous with the spindle motor's rotational speed. By determining the harmonic components of the PES and the spindle motor's rotational frequency, an effective control strategy can be designed to reduce the RRO from the PES measurements by allowing the head 304 to follow the repeatable path of the PES, thus canceling out the RRO from the PES measurements.

In order to cancel out the impact of the RRO component (i.e. disturbance) on the tracking error of the closed loop servo loop in a disc drive, a feed forward current or control signal is added to the tracking controller current in the closed servo loop of the disc drive. By taking measurements at different locations on the disc, this additional control signal, injected into the summing digital analog converter (DAC), directs the head to follow the RRO portion (a combination of the sinusoidal shape position error) of the PES. The RRO harmonics determined at multiple points on a disc allow for the application of corrective signals (described below) to these points on the disc. Furthermore, this feed forward control signal gets updated after measuring PES at a number of locations. The harmonics of the PES are determined using Discrete Fourier Transforms (DFTs) and the feed forward control signal is adapted to remove the RRO harmonics.

The additional feed forward control signal is referred to as an Adaptive Runout Correction System (ARCS). ARCS values represent compensation values/signals that are added as a feed forward compensation signal to correct the head positioning control signal to decrease the RRO harmonics. ARCS values consist of the summation of several sinusoidal signals with each sinusoidal signal having a fundamental frequency equivalent to a fundamental frequency of the spindle motor's harmonics with the amplitude adapted to remove the RRO at the desired harmonics.

However, RRO harmonics are not always a good indication of a spindle motor problem, because RRO harmonics can change over time. Over time, the RRO harmonics may result in larger differences in ARCS values, and these differences may not always indicate impending spindle motor problems. Thus, it may be desirable to use the ARCS values to cancel out the RRO harmonics of PES measurements from a disc drive, thereby correcting disc eccentricities.

ARCS values are calculated using Discrete Fourier Transforms (DFTs). A real time DFT of the PES for the first several harmonics is calculated. In some implementations, single frequency DFTs are used to adapt the analysis so that the lower harmonics of RRO can be tracked and canceled out (if necessary).

ARCS values are calculated for certain harmonics using DFTs in an algorithm which may be represented, for example, as 1X, 2X, 3X, 4X, 5X, 6X, 12X, 18X, although other harmonics may be used. In this exemplary formula X represents the speed of the rotation of the spindle motor in Hertz. In this example, an ARCS value may be calculated for each frequency and these values may be continually determined and stored on a disc drive. These ARCS values are related to the amplitude of the RRO harmonics of the disc drive. The differences or delta of ARCS values over time can be analyzed by comparing the absolute maximum changes in DFT values over time. In an alternative implementation, the maximum absolute change of the ARCS values coefficients over all harmonics is calculated to determine delta ARCS values.

The above algorithm is used to determine ARCS values as coefficients at each zone and surface of the disc when the power is initially turned on. The ARCS values coefficients from the initial script write (i.e. power on) are stored in the non volatile RAM of the disc drive. Each time a new ARCS value is determined and stored, the previously determined and stored ARCS values are retrieved from the drive and compared to the initial ARCS values at startup (i.e. power on). If the difference or delta between the most recent or current ARCS values and the initial ARCS values satisfies a second threshold condition, then an alert will be issued. Differences, or the delta, between ARCS values is a measure of the magnitude of the absolute changes in harmonics over time.

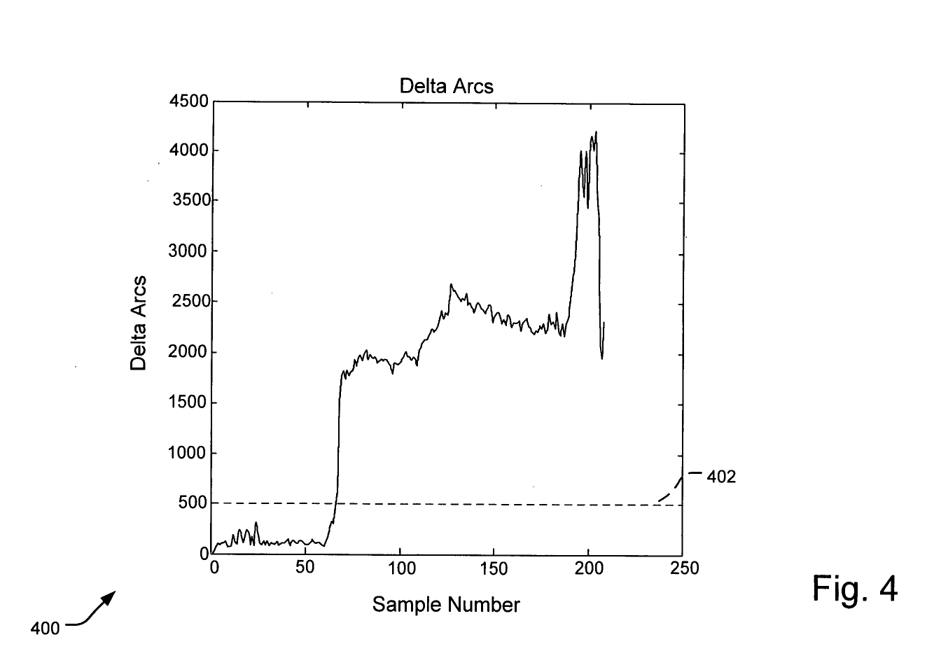

FIG. 4 is a chart 400 illustrating exemplary ARCS values collected for a number of different samples. The change, or delta, in ARCS values can clearly be seen as a steep increase at 500, illustrated with dashed line 402. Dashed line 402 illustrates detection of a significant difference between ARCS values determined at an initial time and at a later time. This difference in ARCS values may be indicative of spindle motor degradation or failure and thus, an alert will be issued to set a flag to perform further verification operations.

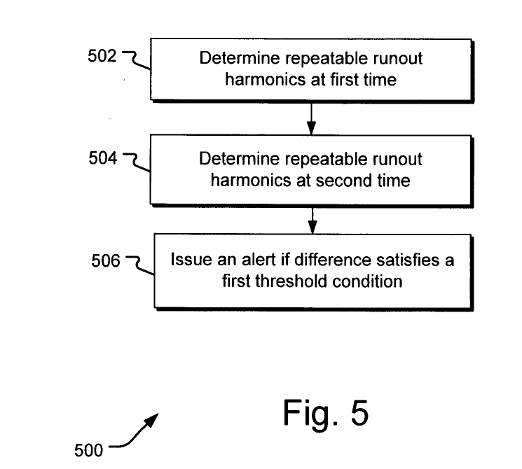

With reference to FIG. 5, in a first exemplary stage of a method 500 of operation, an alert will be issued 506 if a first difference between feed forward compensation signals of repeatable runout determined at a first time 502 and feed forward compensation signals of repeatable runout determined at a second time 504 satisfies a first threshold condition. The feed forward compensation signals of repeatable runout determined at the first time 502 may be determined at spindle motor initialization or startup and the feed forward compensation signals of repeatable runout determined at a second time 504 may be determined at some later time. In some implementations, determining the feed forward compensation signals of repeatable runout may comprise determining ARCS values.

If the first difference between the feed forward compensation signals of repeatable runout determined at the first and second times (or ARCS values determined at first and second times) satisfies or exceeds a first threshold condition, then an alert will be issued 506. In some implementations, the alert 506 may comprise the setting of a flag to commence a second stage of a method of detection. If the first difference does not satisfy the first threshold condition, then no action will be necessary and operations will continue as normal. This initial flag also helps to ensure the performance of the disc drive will not be hindered or interrupted unless and until there is some indication that the disc drive is having a spindle motor problem.

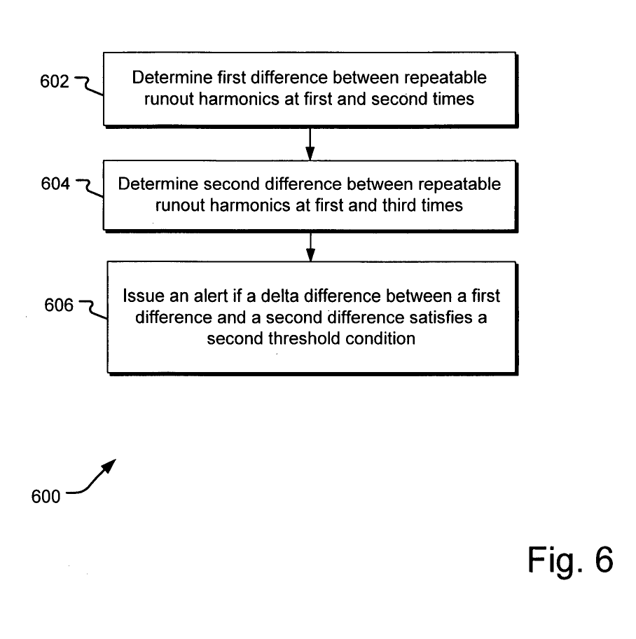

With reference to FIG. 6, in a second exemplary stage of a method 600 of operation, an alert will be issued 606 if a second difference between first and second differences satisfies a second threshold condition. The first difference will be determined as described above 602 (with regard to FIG. 5 and first stage method of operation). The second difference will be determined 604 by determining a difference between feed forward compensation signals of repeatable runout at the first time and feed forward compensation signals of repeatable runout at a third time.

The difference, or delta difference, between the first and second differences will then be determined. In some implementations, these differences may be determined using feed forward compensation signals of repeatable runout and in others they may be determined using ARCS values to determine the difference or delta of the ARCS values. If the difference between the first and second differences does not satisfy the second threshold condition, then issuing an alert may comprise recalibrating the first threshold condition. Recalibrating the first threshold condition may occasionally be necessary to adapt to changes in disc drive conditions to prevent misleading alerts or flags.

If the difference between the first and second differences satisfies a second threshold condition, then an alert will be issued 606. In some implementations, issuing an alert will comprise setting a flag and/or sending a notification to a user to commence data backup operations immediately to prevent loss of data due to imminent spindle motor (e.g. disc drive) failure. If a flag is set the disc drive will go into an error recovery mode, or a drive diagnostic mode, where the operations of the disc drive are stopped and the disc drive is dedicated to locating and correcting the error. Once the error recovery mode has commenced, the feed forward compensation signals will be measured for all heads at inner disc diameters and out disc diameters. These measurements can be taken a number of times and the frequency range can be adjusted depending on the disc drive mechanics.

In order for the flag to be set, there are several conditions which must be met. First, the delta ARCS values measured should be higher than the flag and should be consistent over a predetermined period of time. The same trend should also be noticed at both the inner disc diameter and the outer disc diameter, because a spindle motor problem would be seen radially across a disc. Additionally, the problem should be seen on all heads. If these conditions are met, than a flag is set to indicate potential disc drive failure. If these conditions are not met, then the error is considered an aberration and the first threshold condition may be reset to adapt to changing disc conditions and eliminate noisy signals or false detection of errors.

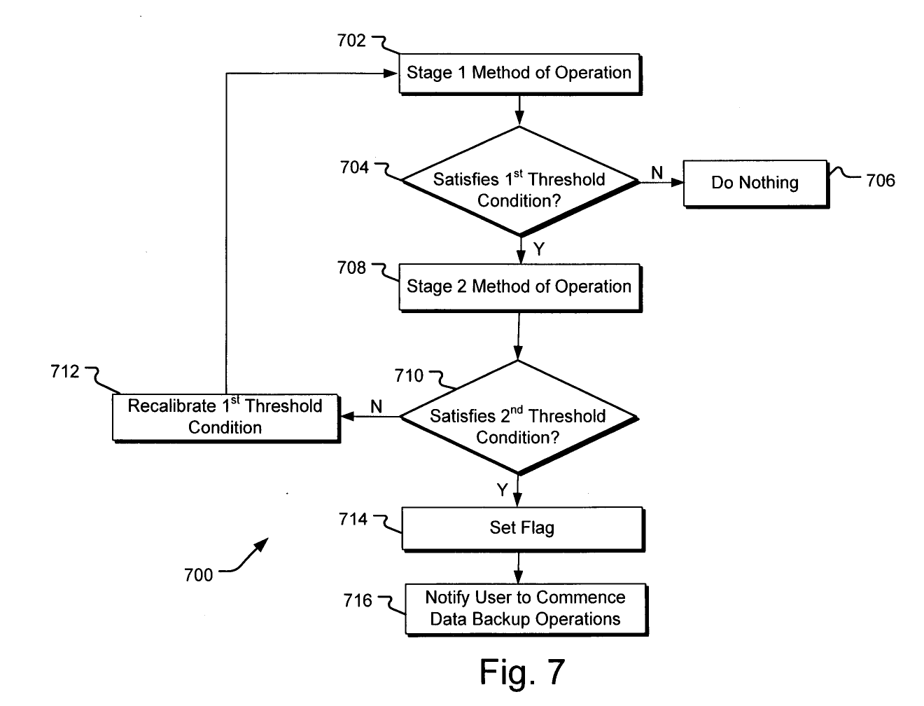

As shown in FIG. 7, the first stage method of operation 702 will determine 704 if a first threshold condition has been satisfied. If the first threshold condition has not been satisfied, then the operations will cease 706. If the first threshold condition has been satisfied, then the operations will proceed to the second stage method of operation 708. The second stage method of operation 708 will determine 710 if a second threshold condition has been satisfied. If the second threshold condition has not been satisfied, then the first threshold condition will be recalibrated 712 or adjusted accordingly. If the second threshold condition has been satisfied, then an alert may be issued. The alert may comprise setting a flag 714 and/or notifying 716 a user to commence data backup operations.

In another implementation, a system comprising control circuitry configured to issue an alert is disclosed. The control circuitry may be configured to issue an alert if a first difference between feed forward compensation signals of repeatable runout determined at a first time and feed forward compensation signals of repeatable runout determined at a second time satisfies a first threshold condition. The control circuitry may also be configured to determine the difference between ARCS values at a first time and ARCS values at a second time.

The control circuitry may further be configured to determine a difference between first and second differences and issue an alert if the difference between the first and second differences satisfies a second threshold condition. As described above, the second difference may be determined by determining the difference between feed forward compensation signals of repeatable runout at the first time and feed forward compensation signals of repeatable runout at a third time.

Embodiments of the present invention will be discussed with reference to a magnetic disc drive. One skilled in the art will recognize that the present invention may also be applied to any data storage device, such as an optical disc drive, a magneto-optical disc drive, or a compact disc drive, that is capable of operating in two or more power levels. Further, one skilled in the art will understand that embodiments of the present invention are equally applicable to any type of electrical or electronic device capable of operating at more than one power level. For example, devices that may implement embodiments of the present invention include but are not limited to notebook computers, handheld devices such as Personal Digital Assistants (PDAs), cell phones, office equipment such as copiers and fax machines, etc.

The technology described herein is implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of example embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

Although the subject matter has been described in language specific to structural features and/or methodological arts, it is to be understood that the subject matter defined in the appended claims is not necessarily limited to the specific features or acts descried above. Rather, the specific features and acts described above are disclosed as example forms of implementing the claimed subject matter.

What is claimed is:

1. A method comprising issuing an alert if a first difference between feed forward compensation signals of repeatable runout determined at a first time and feed forward compensation signals of repeatable runout determined at a second time satisfies a first threshold condition.

2. The method of claim 1, further comprising determining the feed forward compensation signals of repeatable runout at the first time by determining adaptive runout correction system (ARCS) values at the first time, and wherein determining the feed forward compensation signals of repeatable runout at the second time comprises determining ARCS values at the second time.

3. The method of claim 2, wherein issuing an alert comprises issuing an alert if a difference between the ARCS values at the first time and the ARCS values at the second time exceeds the first threshold condition.

4. The method of claim 1, further comprising calculating the first difference between the feed forward compensation signals of repeatable runout at the first time and the feed forward compensation signals of repeatable runout at the second time by subtracting coefficients of individual harmonics of the feed forward compensation signals of repeatable runout at the first time from coefficients of corresponding individual harmonics of the feed forward compensation signals of repeatable runout at the second time.

5. The method of claim 1, further comprising:
determining a second difference between feed forward compensation signals of repeatable runout at the first time and feed forward compensation signals of repeatable runout at a third time;
determining a difference between the first and second differences; and
issuing an alert if the difference between the first and second differences satisfies a second threshold condition.

6. The method of claim 5, wherein issuing an alert comprises setting a flag, if the difference between the first and second differences satisfies the second threshold condition.

7. The method of claim 5, wherein issuing an alert comprises sending a notification to a user to commence data backup operations, if the difference between the first and second differences satisfies the second threshold condition.

8. The method of claim 5, wherein issuing an alert further comprises recalibrating the first threshold condition, if the difference between the first and second differences has not satisfied the second threshold condition.

9. The method of claim 5, wherein the operation of determining a second difference between the feed forward compensation signals of repeatable runout at the first time and the feed forward compensation signals of repeatable runout at the third time comprises:
determining a first ARCS value at the first time;
determining a second ARCS value at the third time; and
determining the second difference between the first ARCS value and the second ARCS value.

10. A method comprising:
issuing an alert if a delta difference between a first difference and a second difference satisfies a second threshold condition;
wherein the first difference represents a difference between feed forward compensation signals of repeatable runout at a first time and feed forward compensation signals of repeatable runout at a second time; and
wherein the second difference represents a difference between feed forward compensation signals of repeatable runout at a first time and feed forward compensation signals of repeatable runout at a third time.

11. The method of claim 10, wherein issuing an alert comprises setting a flag.

12. The method of claim 10, wherein issuing an alert comprises sending a notification to a user to commence data backup operations, if the difference between the first and second differences satisfies the second threshold condition.

13. The method of claim 10, wherein issuing an alert further comprises recalibrating the first threshold condition, if the difference between the first and second differences has not satisfied the second threshold condition.

14. The method of claim 10, wherein determining a second difference between the feed forward compensation signals of repeatable runout at the first time and the feed forward compensation signals of repeatable runout at the third time comprises:
determining a first ARCS value at the first time;
determining a second ARCS value at the third time; and
determining the second difference between the first ARCS value and the second ARCS value.

15. The method of claim 10, further comprising calculating the first difference between the feed forward compensation signals of repeatable runout at the first time and the feed forward compensation signals of repeatable runout at the second time by subtracting coefficients of individual harmonics of the feed forward compensation signals of repeatable runout at the first time from coefficients of corresponding individual harmonics of the feed forward compensation signals of repeatable runout at the second time.

16. A system comprising control circuitry configured to issue an alert if a first difference between feed forward compensation signals of repeatable runout determined at a first time and feed forward compensation signals of repeatable runout determined at a second time satisfies a first threshold condition.

17. The system of claim 16, wherein the control circuitry is further configured to determine the feed forward compensation signals of repeatable runout at the first time by determining ARCS values at the first time, and determine feed forward compensation signals of repeatable runout at the second time by determining ARCS values at the second time.

18. The system of claim 16, wherein the control circuitry is further configured to:
determine a second difference between the feed forward compensation signals of repeatable runout at the first time and repeatable runout harmonics at a third time;
determine a difference between the first and second differences; and
issue an alert if the difference between the first and second differences satisfies a second threshold condition.

19. The system of claim 16, wherein determining the second difference between the feed forward compensation signals of repeatable runout at the first time and the feed forward compensation signals of repeatable runout at the third time comprises:
determining a first ARCS value at the first time;
determining a second ARCS value at the third time; and
determining the second difference between the first ARCS value and the second ARCS value.

20. The system of claim 16, wherein control circuitry configured to issue an alert comprises control circuitry configured to send a notification to a user to commence data backup operations, if the difference between the first and second differences satisfies the second threshold condition.
